(19) United States
(12) Patent Application Publication
(10) Pub. No.: US 2003/0154990 A1
(43) Pub. Date: Aug. 21, 2003

(54) Mouthpiece monitor

(76) Inventor: Robert W. Parker, San Antonio, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/367,416

(22) Filed: Feb. 14, 2003

Related U.S. Application Data
(60) Provisional application No. 60/358,055, filed on Feb. 19, 2002.

(51) Int. Cl. A61C 5/14

(52) U.S. Cl. 128/861

(57) ABSTRACT

A mouthpiece temperature monitor. The mouthpiece is to be worn by a subject during physical activity. The mouthpiece also houses a temperature sensor for detection of a temperature of the subject.

### RELATED APPLICATION

This application claims priority from U.S. Provisional Patent Application Serial No. 60/358,055 entitled “Mouthpiece Monitor” filed Feb. 19, 2002.

### BACKGROUND

Embodiments disclosed herein relate to temperature monitors. In particular, embodiments relate to temperature monitors configured to activate an alarm based upon analysis of temperature information.

### BACKGROUND OF THE RELATED ART

In the last several years, concern over body temperature during exercise has increased. Along with an increase in the number of individuals participating in physically strenuous activities has come an increase in the number of documented deaths and complications linked to abnormal body temperatures. Physical activity of any kind may lead to abnormal body temperatures of concern. Sports such as football, basketball, soccer, running and others can lead to participant subjects experiencing unhealthy body temperatures. For example, given the proper circumstances, an elevation in body temperature can lead to heat exhaustion, heat stroke and perhaps even death. The noticeable increase in such documented complications is not limited to any particular sport, activity, or level of experience. Whether the individual is a professional football player or a casual jogger, the consequences of experiencing abnormal body temperatures may be quite severe.

In order to address such concerns, body temperature monitors have been developed to monitor a subject's body temperature during physical activity. Whereas oral thermometers, for example, are not practical for use during most physical activities, a device may be configured to read a subject's temperature and have the temperature displayed in a readable manner at an external location. For example, an earpiece incorporating a thermister may be placed in a subject's ear. The earpiece may be wired to an external arm or wristband where a body temperature of the subject may be displayed. Additionally, the arm or wristband may incorporate an alarm to alert the subject or others when an abnormal body temperature is detected.

Alternative monitors exist to the above earpiece-based monitor. For example, wireless monitors are also known. Such monitors are configured with a transmitter maintained external to the body for the transmission of temperature information to a remote location

Unfortunately, the monitors described above are not particularly suited for use when engaging in physical activity. For example, a monitor incorporating a significant presence of external wires or a bulky transmitter external to the subject may be distracting, unstable and even hazardous. This is especially true when such devices are worn during participation in a physical activity involving contact such as football or basketball. In fact, the significant presence of any component that is both external to the subject and the athletic equipment generally used during a given physical activity will have its drawbacks.

### SUMMARY

In one embodiment, a mouthpiece is provided to be worn by a subject during physical activity. The mouthpiece houses a temperature sensor for detection of a temperature of the subject.

### BRIEF DESCRIPTION OF THE DRAWINGS

FIG. 1 is a perspective view of an embodiment of a mouthpiece monitor.

FIG. 2 is a perspective view of an alternative mouthpiece monitor embodiment.

FIG. 3 is a flow-chart summarizing embodiments of certain temperature monitoring methods.

### DETAILED DESCRIPTION

Descriptions of embodiments of mouthpiece monitors are provided. Features of the embodiments disclosed are described and illustrated by the accompanying drawings. While embodiments are described with reference to particular mouthpieces, the embodiments are applicable to any mouthpiece for use during physical activity that incorporates a temperature sensor. Embodiments disclosed are particularly useful when used in sports that may involve contact such as football, basketball, hockey, boxing and others.

Embodiments described below are generally applicable to mouthpieces to be worn by a subject during physical activity that include temperature sensing capacity. The mouthpiece may house a processor coupled to the temperature sensor for analyzing information obtained from a detected temperature of the subject. The processor may also be coupled to an alarm that may be activated based upon analyzation of the information.

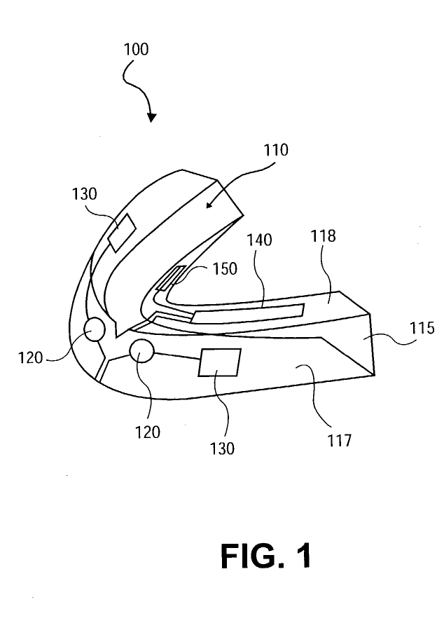

Referring to FIG. 1, an embodiment of a self-contained mouthpiece monitor 100 is shown. In this embodiment, mechanisms for temperature detection, analysis and even the sounding of an alarm, if need be, are all contained within a body 110 of the mouthpiece monitor 100, as described further herein. However, it is not required that all such features be found within the body 110. Nevertheless, by including all of these features within the mouthpiece body 110, a subject may participate in physical activity completely free of any external features that could hinder athletic performance. For example, whether jogging, hiking, playing lacrosse, football, soccer, or basketball, the subject may place the mouthpiece monitor 100 in the mouth and participate in the physical activity without requiring any additional, and potentially hindering, device (or device features) for temperature detection, analysis, or the sounding of an alarm.

Many physical activities already incorporate use of a mouthpiece to prevent oral injury during a physical activity that may involve contact. The mouthpiece monitor 100 shown may be used as such a mouthpiece or guard to help prevent oral injury. Therefore, temperature detection, analysis, or the sounding of an alarm, may be achieved without requiring any equipment not already used for such physical activities. Rather, for example, a football player may replace a conventional mouthpiece or guard with the mouthpiece monitor 100 and continue to participate in the physical activity of football as normal.

Continuing with reference to FIG. 1, features of the mouthpiece monitor 100 are described. The mouthpiece monitor 100 includes a body 110 that may be of conventional mouthpiece materials such as rubber, polyvinyl and other materials. The body 110 shown is transparent due to the material used and includes conventional front 117 and back 118 portions with a bite plane 115 there between. The portions 117, 118 may have a height between about 0.25 inches and about 1.00 inches depending on the sizing required by the subject. Additionally, the mouthpiece monitor itself may be from between about 1.5 inches and about 3.0 inches from front to back. As in conventional mouthpieces, the body 110 may come in a variety of mouth sizes or be custom fit for a subject.

In the embodiment shown, a forward surface of the front portion 117 contacts an inner portion of the subject's upper lip, while a forward surface of the back portion 118 contacts the roof of the subject's mouth. Additionally, as with the sizing noted above, the particular shape of the body 110 is also a matter of design choice and dependent upon the morphology of the subject's mouth.

In the embodiment shown power sources 130 coupled to temperature sensors 120 are embedded into the front portion 117 of the body 110. The temperature sensors 120 may be conventional thermistors embedded in the body 110 within a close proximity of the forward surface of the front portion 117, within 0.1 mm, for example. In one embodiment, the temperature sensors 120 are of a shape and size to be entirely embedded within and encapsulated by the material of the body 110.

The particular positioning, number, and type of temperature sensors 120 are a matter of design choice. However, the temperature sensors 120 should be placed so as to obtain a reliable oral temperature of a subject wearing the mouthpiece monitor 100. For example, in the embodiment shown, the particular material chosen to form the body 110 may be a factor in selecting a depth to which a temperature sensor 120 is embedded, making sure that the temperature sensor 120 stays close enough to the surface of the front portion 117 to detect an oral temperature from the upper lip of the subject.

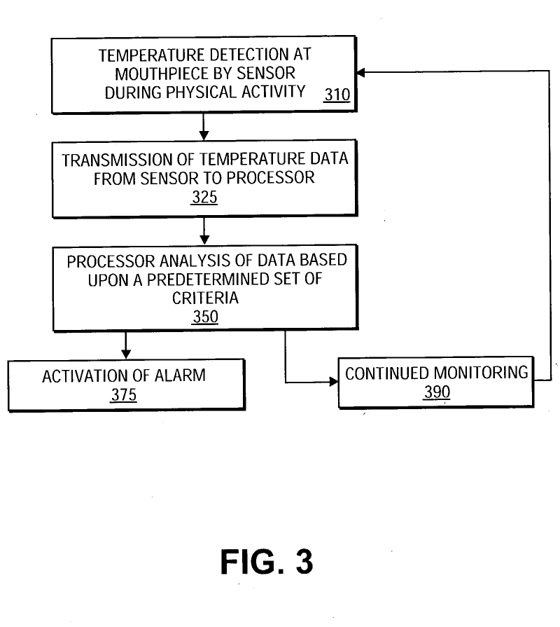

As a subject wearing the mouthpiece monitor 100 engages in physical activity, the temperature sensors 120 may continuously feed analog temperature data to a processor 140 embedded in another portion of the body 110 such as the back portion 118. As pointed out in FIG. 3, monitoring may begin with the temperature sensor 120 detecting a temperature 310. Temperature data may then be transmitted 325 to the processor 140 which performs analysis of the data based upon a predetermined set of criteria 350. FIG. 3 is referenced throughout the remainder of this description, in conjunction with other FIGS. to provide greater detail concerning certain methods of monitoring made possible by operating embodiments of mouthpiece monitors.

Continuing with reference to FIGS. 1 and 3, the processor 140 may receive analog temperature data from a temperature sensor 120 and convert the data to digital information. The processor 140 then performs analysis on the digital information based on a predetermined set of criteria 350. Depending .on the results of the analysis, the processor 140 either activates an alarm 375 or monitoring is continued 390.

The predetermined set of criteria noted above may be a host of values against which the digital temperature information is compared during the analysis. For example, in one embodiment, when a temperature of at least about 102° F. (e.g. stored in the processor 140 as predetermined criteria) is detected at the temperature sensor 120, the processor 140 will activate an alarm 150, described further herein.

In another embodiment, the predetermined criteria will include a temperature value and a time value. For example, in one embodiment, temperature information fed to the processor 140 is compared to a stored value of, for example, about 100° F. The processor 140 does not activate the alarm 150 immediately. However, when the predetermined value of about 100° F. is maintained continuously for about 25 minutes, for example, the processor 140 will activate the alarm 150.

In yet another embodiment, the predetermined criteria will include rate values. For example, when a temperature increase greater than, for example, about 1° F. per minute is detected, the processor 140 will activate the alarm. In this embodiment, the processor 140 may be programmed to perform such analysis only once a temperature of greater than about 95° F. is detected. In cases where the subject cools off, for example, by drinking cold water, the oral temperature of the subject will be greatly reduced momentarily. When the subject resumes physical activity, it may be expected that the subject will rapidly regain a normal oral temperature. By having the processor 140 perform the rate analysis described in this embodiment only once a normal oral temperature is detected, false alarms are prevented.

As noted above, the mouthpiece monitor 100 detects an oral temperature. The oral temperature is indicative of a subject's core body temperature. However, it is actually the core body temperature that is of physiological concern where heat exhaustion, heat stroke, and other complications are to be prevented. Nevertheless, under normal conditions, the oral temperature is linearly related to the core body temperature in that it is generally about 0.5° F. lower. Therefore, when the processor 140 obtains analog information from the temperature sensor 120, the analysis performed may include the processor 140 interpolating the analog temperature information by automatically adding 0.5° F. to the reading obtained. Thus, when establishing the set of predetermined criteria, every value does not need to be modified to account for the difference seen between oral and core body temperatures. Additionally, in an embodiment where the processor 140 is to feed digital temperature information to a Liquid Crystal Display (LCD) (not shown) at the front of the mouthpiece sensor 100, the temperature displayed will represent the core body temperature of concern.

Embodiments of analysis of temperature information by the processor 140 described above include analysis based on a temperature reached, a duration of time a temperature is maintained, and a rate of change in temperature. In one embodiment, the processor 140 performs all of these analyses simultaneously. Therefore, the alarm 150 is subject to being activated under a host of conditions that may be of physiological concern. Additionally, in embodiments where multiple temperature sensors 120 are provided, as shown in FIG. 1, the processor 140 may take an average of readings obtained, or perform analysis utilizing the readings providing the highest temperature, longest duration of critical temperature, or the highest rate of temperature increase, as the case may be according to the embodiments described above.

In another embodiment, the digital information generated by the processor 140 is stored, for example, in flash RAM memory of the processor 140. In this embodiment, no analysis is performed on the digital information. Rather, the subject is monitored, for example, by a physician, to determine the physiological effects of different temperatures reached by the subject during physical activity. In this manner, the digital information that is stored may be downloaded, analyzed, and later used to calibrate or modify, if necessary, the values representing the predetermined set of criteria. In other words, a physician is able to, for example, closely monitor a particular subject to determine with better accuracy, the particular temperatures, duration of temperatures reached, or rate of temperature increase that is of concern during the physical activity. What is learned during such a test may then be used to modify the predetermined set of criteria and resulting analysis undertaken by the processor 140 for determining alarm activation.

Referring again to FIG. 1, the processor 140 is coupled to an alarm 150 embedded within a portion of the mouthpiece sensor 100. In the embodiment shown, the alarm 150 is positioned at the back portion 118 of the mouthpiece sensor 100. However, the alarm 150 may be positioned in other portions of the mouthpiece sensor 100. For example, in another embodiment, the alarm 150 is embedded within the front portion 117.

The alarm 150 may be any audible device loud enough so that the subject of normal hearing is able to detect its activation. In one embodiment the alarm 150 includes a piezo-electric element housed within a cavity large enough to allow vibration of the element to produce a beeping sound. Such piezo-electric elements are known to produce sounds exceeding 80 decibels. This is more than loud enough to be heard by the subject of normal hearing and persons in the immediate vicinity, even where the element is encased within a cavity of the mouthpiece monitor 100, as shown. When the alarm 150 is sounded during physical activity, the subject is alerted to the hazard of an abnormal body temperature and may cease the physical activity, take measures to regain a normal body temperature and seek medical attention if necessary.

The above mouthpiece monitor 100 is described for use in certain physical activities that may be thought of as exercise or sport. However, the mouthpiece monitor 100 may be utilized for a host of other activities. For example, the mouthpiece monitor 100 may be used by firefighters whose activities already include the hazard of exposure to higher temperatures.

The temperature of concern during the physical activity may not always be an abnormally high temperature. Activities such as mountain climbing and swimming may include the risk of abnormally low or decreasing body temperatures which can lead to the subject experiencing hypothermia. Therefore, in one embodiment the processor 140 of the mouthpiece monitor 100 is programmed for analysis based upon a predetermined set of criteria that includes values accounting for the hazards of lowered body temperature. Additionally, since all components of the mouthpiece monitor 100 are sealably encased within the body 110 in a waterproof manner, the mouthpiece monitor 100 is particularly useful where the subject is exposed to water during a physical activity, such as swimming as noted above.

In addition to individualized sizing and shaping of the mouthpiece monitor 100, as noted above, the processor 140 may include a fairly individualized set of predetermined criteria for use in performing analyses. For example, where the processor 140 is to activate the alarm 150 based on a rate of temperature increase, the rate of increase, as a predetermined criteria, may be set at one level for persons of average size, and at a second, lower rate, for persons of larger than average sizes. In this way, as temperature increases, the alarm 150 will be activated more readily for heavier persons who may possibly be at greater health risk for high body temperature associated injuries.

The mouthpiece monitor 100 may also be individualized based on the ambient temperature to which the subject is exposed. For example, where the mouthpiece monitor 100 is to be used in the summer in the desert southwest of the U.S., the rate of temperature increase for example, as a predetermined criteria, may be set at a lower level than mouthpiece monitors 100 for use in the northeastern U.S. In this way, the alarm 150 is again activated more readily based on rate of temperature increase, in areas where ambient temperature is likely to make regaining a normal body temperature more difficult.

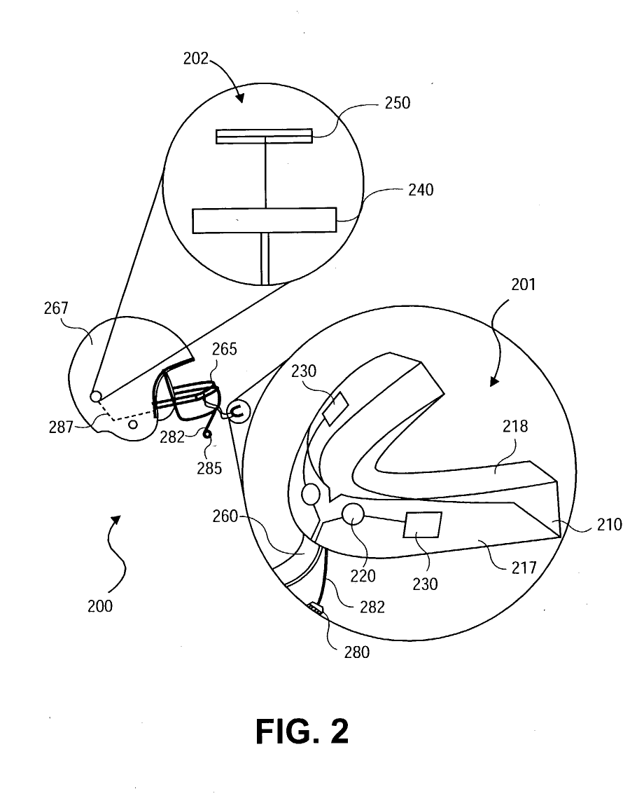

Referring to FIG. 2, an alternate embodiment of a mouthpiece monitor 201 is shown. The mouthpiece monitor 201 is part of a monitoring assembly 200 that includes a mouthpiece monitor 201 coupled to a separately housed equipment portion 202. The equipment portion 202 is a modified portion of a piece of equipment naturally used during a particular activity. For example, in the embodiment shown, a football helmet 267 is shown as a piece of equipment. Without altering the outer body of the football helmet 267, an equipment portion 202 is used to house a processor 240 coupled to an alarm 250. By housing these components within equipment naturally used in the physical activity of football or related drills, no extraneous or otherwise obtrusive features are present as temperature is monitored. Thus, the physical activity continues without hindrance to the subject participant.

Similar to the embodiment shown in FIG. 1, the mouthpiece monitor 201 of FIG. 2 includes at least one temperature sensor 220 coupled to a power source 230. In the embodiment shown, these components are again embedded within a front portion 217 of the mouthpiece monitor 201. However, no components are housed at the back portion 218 of the mouthpiece monitor 201. Rather, the temperature sensors 220 are wired to the equipment portion 202.

In the embodiment shown, the temperature sensors 220 are electronically coupled to external wiring 282 that travels along a path adjacent a strap 260 of the mouthpiece monitor 201. The strap 260 physically secures the mouthpiece monitor 201 to the football helmet 267 at the facemask 265 in a detachable manner. The external wiring 282 includes a female plug 280 and a male plug 285 to allow the mouthpiece monitor 201 to be detachably coupled to the football helmet 267. Thus, the mouthpiece monitor 201 may be completely removed and replaced. While the external wiring 282 described herein is external to the football helmet 267 and the subject, it is of fairly negligible size and does not interfere with physical activity.

In one embodiment, the external wiring 282 is slightly longer than the strap 260, between the mouthpiece monitor 201 and the facemask 265. This allows movement of the mouthpiece monitor 201 while ensuring that a connection is maintained between the female 280 and male 285 plugs.

The external wiring 282 is coupled to embedded wiring 287 of the football helmet 267 which runs internally from the facemask 265 to the equipment portion 202. In this manner, the short external wiring 282 is the only feature of the monitoring assembly 200 which is present external to the equipment naturally used during the physical activity of football or related drills. As such, no features are present which may hinder the subject's physical activity.

In another embodiment, the temperature sensors 220 are coupled to the embedded wiring 287 through wiring that runs internal to the strap 260. In this manner, no features at all are present external to the equipment naturally used during the physical activity.

In the embodiment described with reference to FIG. 2, the processor 240 and alarm 250 may function as described with reference to FIG. 1. However, in this embodiment, the mouthpiece monitor 201 may be replaced without replacement of the processor 240 or alarm 250. Thus, the expense of a processor 240 and alarm 250 is not incurred each time a new mouthpiece monitor 201 is to be used.

In another embodiment, the processor 240 is coupled to a transmitter within the equipment portion 202. The transmitter may be used to send digital instruction to an alarm external to the football helmet 267. In this way, the alarm may be monitored by persons other than the subject. Additionally, in another embodiment, the equipment portion 202 may include a transmitter in place of both the processor 240 and the alarm 250. In this embodiment, analog information may be transmitted to a receiving device external to the football helmet 267 which houses both the processor 240 and the alarm 250.

Embodiments similar to that shown in FIG. 2 are particularly useful where the equipment natural to the physical activity include a helmet or other feature near the mouth of the subject which may accommodate an equipment portion 202. For example, firefighting or other hazardous environment equipment may include a protective head covering. Additionally, during a physical activity in a hazardous environment such as firefighting, it may be advantageous to have a person other than the firefighter monitor the body temperature of the firefighter. Therefore, an embodiment, as described above, which includes a transmitter in the equipment portion 202 may be used during such physical activity.

Referring to FIG. 3, a method of monitoring temperature of a subject with a mouthpiece monitor is shown in the form of a flow-chart. Namely, a sensor detects a temperature 310 that is transmitted to a processor 325. The processor analyzes the temperature data based upon a predetermined set of criteria 350. Depending upon the analysis, either an alarm is activated 375 or monitoring continues 390.

When a subject experiences abnormal body temperatures, early detection of the risk may be key in preventing physiological injury as a result thereof. Embodiments described above are suited for use during physical activity in manners that are unobtrusive to the physical activity engaged in by the subject. A mouthpiece monitor is provided that is worn orally and not external to the subject. Additionally, when components are utilized external to the subject, they are housed substantially within equipment natural to the physical activity undertaken by the subject. This encourages use of a mouthpiece monitor and monitoring of potentially hazardous abnormal body temperatures to prevent injury to the subject.

Embodiments described above include a mouthpiece monitor housing a temperature sensor. Additionally, the embodiments described include a processor and an alarm to analyze and alert a subject of potentially hazardous body temperatures. Although exemplary embodiments describe particular mouthpiece monitors for use during particular physical activities, additional embodiments are possible. For example, a mouthpiece monitor as described above may include a removable portion separately housing features such as the processor and alarm. The removable portion may be reusable or stored separate from the remainder of the mouthpiece for safekeeping and to help control expense. Additional features such as a power source or LCD may be housed in the removable portion. Additionally, many changes, modifications, and substitutions may be made without departing from the spirit and scope of the described embodiments.

I claim:

1. An apparatus comprising:
a mouthpiece to be worn by a subject during physical activity; and
a temperature sensor housed within said mouthpiece for detection of a temperature of the subject.

2. The apparatus of claim 1 further comprising a processor coupled to said temperature sensor for obtaining data from the detection and for analyzing the data based upon a predetermined set of criteria.

3. The apparatus of claim 2 further comprising an alarm coupled to said processor to be activated based upon the analyzing.
